(19) United States
(12) Patent Application Publication
(10) Pub. No.: US 2025/0094846 A1
(43) Pub. Date: Mar. 20, 2025

(54) CHANGE DETECTION IN HIGH-DIMENSIONAL DATA STREAMS USING QUANTUM DEVICES

(71) Applicant: Fujitsu Limited, Kawasaki-shi (JP)

(72) Inventors: Alice DIDENKOVA, Sunnyvale, CA (US); Sarvagya UPADHYAY, San Jose, CA (US)

(73) Assignee: Fujitsu Limited, Kawasaki-shi (JP)

(21) Appl. No.: 18/468,358

(22) Filed: Sep. 15, 2023

(51) Int. Cl. G06N 10/20; G06N 10/60

(52) U.S. Cl. CPC G06N 10/20; G06N 10/60

(57) ABSTRACT

A method may include obtaining a first and a second quantum state that represent different subsets of a multivariate dataset. The method may include configuring a quantum circuit that includes an ancillary qubit initialized to a zero state, a first qubit including the first quantum state, and a second qubit including the second quantum state. The method may include applying a first Hadamard transformation to the ancillary qubit, and responsive to the first Hadamard transformation returning a particular value, swapping the first and second qubits such that the second qubit represents the first quantum state and the first qubit represents the second quantum state. The method may include applying a second Hadamard transformation to the ancillary qubit, and responsive to observing a measurement outcome of zero, it may be determined that a changepoint does not occur between the data samples corresponding to the first and second data subsets.

The present disclosure generally relates to change detection in high-dimensional data streams using quantum devices.

### BACKGROUND

Quantum computers may use quantum bits (“qubits”) capable of representing information as ones, zeroes, or ones and zeroes simultaneously. Quantum computers may perform some types of computations, such as optimization problems, integer factorization, simulation modeling, and/or data analysis, more efficiently and/or more accurately than classical computing systems. A quantum logic gate, or quantum gate, may represent unitary matrices that may be applied to one or more qubits to reversibly transform the qubits and perform logic operations.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include obtaining a first and a second quantum state that represent different subsets of a multivariate dataset. The method may include configuring a quantum circuit that includes an ancillary qubit initialized to a zero state, a first qubit including the first quantum state, and a second qubit including the second quantum state. The method may include applying a first Hadamard transformation to the ancillary qubit, and responsive to the first Hadamard transformation returning a particular value, swapping the first and second qubits such that the second qubit represents the first quantum state and the first qubit represents the second quantum state. The method may include applying a second Hadamard transformation to the ancillary qubit, and responsive to observing a measurement outcome of zero, it may be determined that a changepoint does not occur between the data samples corresponding to the first and second data subsets.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is a diagram of an example operating environment for determining whether a changepoint occurs in high-dimensional datasets according to one or more embodiments of the present disclosure.

FIG. 2 illustrates an example dataset that includes a changepoint.

FIG. 3 illustrates an example data streaming process according to one or more embodiments of the present disclosure.

FIG. 4 illustrates a second example swap test according to one or more embodiments of the present disclosure.

FIG. 5 is a flowchart of an example method of determining whether a changepoint occurs in high-dimensional datasets according to one or more embodiments of the present disclosure.

FIG. 6 is an example computer system according to one or more embodiments of the present disclosure.

### DETAILED DESCRIPTION

Statistically analyzed datasets relating to highly complex subject matter may include large numbers of variables by which data included in these complex datasets are characterized. For example, datasets relating to biological sciences, such as hospital patient information, may be described with respect to several different variables including ages, heights, weights, medical histories, specific genetic characteristics, health behaviors, drug predispositions, and any other health-related information about the patients. As additional or alternative examples, datasets relating to subject matters such as computer vision, stock market performance, or text analysis may also include different variables by which data samples included in the datasets may be described. In some situations, such datasets may include a greater number of variables by which the data is represented than the sample size of the datasets and may be referred to as high-dimensional data.

High-dimensional data may be difficult to analyze according to existing methods of statistical analysis. Existing statistical measures, such as linear regression parameters and standard deviation values, may not accurately describe the data samples included in high-dimensional data due to the relatively smaller number of data samples and the relatively larger number of variables by which the data samples may be analyzed. Additionally or alternatively, high-dimensional data may be difficult to process due to data entries included in high-dimensional datasets having larger digital file sizes. Consequently, not only does storage of high-dimensional data pose a potential hurdle, but allocation of computing resources to process and analyze the high-dimensional data may also be challenging.

In analyzing the high-dimensional data, changepoints may be important statistical metrics that facilitate analysis of the datasets. A changepoint may indicate a time point in a time-ordered dataset at which a statistically significant change has occurred in the collected data. Detecting changepoints may be important for analyzing a particular dataset because the changepoint may be an identifiable, quantitative representation of a shift in the behavior of the data samples included in the particular dataset. For example, detecting a changepoint may facilitate identifying the point at which an upward trend or a downward trend in the dataset begins or ends. Additionally or alternatively, understanding implications and characteristics of the data at or around changepoints may improve analysis and prediction of future behaviors of a dataset.

For traditional datasets that include relatively larger sample sizes and fewer descriptive data variables, changepoints may be detected based on shifts in statistical parameters, such as a mean, variance, or correlation of the data. Such detection methods, however, may not be applicable to high-dimensional datasets because the changepoint in a multivariate, high-dimensional dataset may or may not be represented in terms of a linear function with respect to the data points included in the dataset. Detection of changepoints in high-dimensional datasets may rely on careful modeling of the dataset and specifically defining what constitutes a changepoint with respect to the dataset.

Quantum computing systems may be well-suited for solving computational tasks that may be challenging for classical computing systems. For instance, classical computing systems may require high amounts of computational resources to determine solutions to complex computational tasks, such as identifying a solution set for an optimization problem. Furthermore, solutions determined by the classical computing system may or may not represent the best solution or even a satisfactory solution to a specified computational task. Because quantum computing systems are configured to represent data as quantum bits, or qubits, that may include quantum states having values of zero, one, or a superpositioned value of one and zero. The capability of quantum computing systems to represent data differently from bits involved in classical computing systems improve the capability of quantum computing systems to solve particular types of computational tasks, such as complex optimization problems and compute with respect to highly multivariate data samples. Therefore, it may be desirable to model computational tasks designed for classical computing system such that a quantum computing system may perform operations relating to the computational tasks.

Modeling a particular computational task for input to a quantum computing system, however, may involve presenting the particular computational task and input information related to the particular computational task in a specific format such that the quantum computing system may obtain and process the information. The way in which classical computing systems obtain and process information is different from the way in which quantum computing systems obtain and process the information. As such, the manner in which a particular computational task and inputs related to the particular computational task are represented as qubits that may be inputted to a quantum computing system may greatly influence how effectively the quantum computing system processes the obtained information and solves the computational task.

The present disclosure may in part relate to modeling a particular high-dimensional dataset as one or more qubits. Processing associated with the qubits may facilitate faster detection of changepoints in the data and with fewer computing resources allocated than using traditional statistical and classical computing approaches. Thus, computing processes and performance of the computer itself may be improved by creating a method and system of more efficiently performing the processing of high-dimensional data according to the present disclosure.

Additionally, due to the file size limitations involving high-dimensional data, a streaming computational model may be implemented to process the high-dimensional data. The streaming computational model may involve obtaining a portion of the dataset being analyzed and performing data analysis processes with respect to the obtained portion of the dataset. After outputting analysis results corresponding to the obtained portion of the dataset, the computing system may obtain a new portion of the dataset for analysis. The data streaming process may involve faster frequencies of data acquisition, in turn result in faster data analysis being needed to process a particular portion of the dataset before receiving a subsequent portion of the dataset, which may be infeasible for classical computing approaches to achieve. Thus, processing the streamed dataset using a quantum computing approach may allow for processing of a particular dataset using the streaming computational model.

Additionally or alternatively, data being analyzed in the streaming computational model may or may not be stored, which may preserve computational resources or decrease usage of computational resources. Because the streamed data may not be stored, anonymous analysis of the data may be performed, which may be beneficial for maintaining data privacy. In one or more embodiments of the present disclosure, the underlying dataset being analyzed may be encoded into one or more quantum states, which may be obtained piecewise as part of a data stream. Determination of a changepoint corresponding to the underlying dataset may or may not involve processing of any of the underlying dataset by the quantum computing system because quantum states encoded based on the underlying dataset may not directly reveal information about the underlying dataset. Furthermore, the quantum computing system may or may not receive a complete representation of the underlying dataset because the encoded quantum states may be obtained piecewise as part of a data stream. Consequently, information about the underlying dataset may be obscured and data privacy improved.

Embodiments of the present disclosure are explained with reference to the accompanying figures.

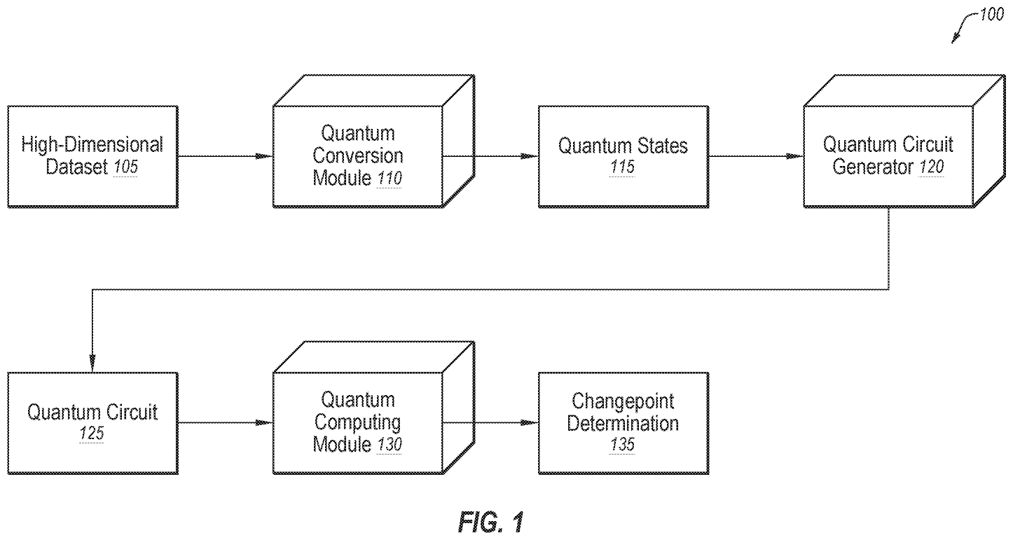

FIG. 1 is a diagram of an example operating environment 100 for determining whether a changepoint occurs in high-dimensional datasets according to one or more embodiments of the present disclosure. The environment 100 may include a quantum conversion module 110 that is configured to output quantum states 115 corresponding to a high-dimensional dataset 105. A quantum circuit generator 120 may generate a quantum circuit 125 based on the quantum states 115, which may be obtained by a quantum computing module 130. Operations performed by the quantum computing module 130 on the quantum circuit 125 according to one or more embodiments of the present disclosure may result in output of a changepoint determination 135.

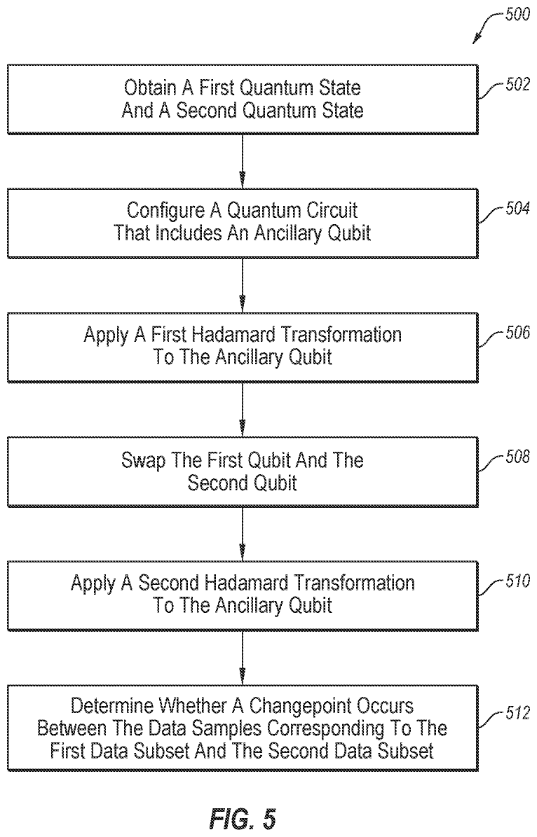

In some embodiments, quantum conversion module 110, the quantum circuit generator 120, and/or the quantum computing module 130 (collectively referred to herein as “the computing modules”) may include code and routines configured to enable a computing system to perform one or more operations. Additionally or alternatively, one or more of the computing modules may be implemented using hardware including a processor, a microprocessor (e.g., to perform or control performance of one or more operations), a field-programmable gate array (FPGA), or an application-specific integrated circuit (ASIC). In some other instances, the computing modules may be implemented using a combination of hardware and software. In the present disclosure, operations described as being performed by the computing modules may include operations that the computing modules may direct one or more corresponding systems to perform. The computing modules may be configured to perform a series of operations with respect to the high-dimensional dataset 105, the quantum states 115, the quantum circuit 125, and/or the changepoint determination 135 as described in further detail below and in relation to an example method 500 as described with respect to FIG. 5.

The high-dimensional dataset 105 may include multivariate data samples in which each data sample is described by multiple different measurable characteristics. In some situations, there may be fewer data samples included in the high-dimensional dataset 105 than characteristics or variables used to describe each of the data samples. For example, a hospital patient dataset may describe the hospital patients according to numerous classifications, including genetic characteristics of the hospital patients. In some cases, the number of hospital patients included the dataset may not be greater than the number of possible genetic characteristics used to describe a particular person, which may represent thousands or tens of thousands of possible data variables. The high-dimensional dataset 105 may be difficult to analyze using traditional statistical analysis approaches because a particular variable may include little data, if any, with which the particular variable may be analyzed. Turning to the previous example relating to the hospital patient dataset, statistical analysis of the dataset with respect to a particular genetic characteristic may yield inaccurate results because an insufficient number of hospital patients may display the particular genetic characteristic to analyze the hospital patient dataset with respect to the particular genetic characteristic.

In some embodiments, the high-dimensional dataset 105 may be represented as a matrix in which each row or column of the matrix represents a particular data entry included in the high-dimensional dataset 105. Additionally or alternatively, the high-dimensional dataset 105 may be represented as a set of multi-dimensional vectors in which each of the data entries included in the high-dimensional dataset 105 is represented as a particular multi-dimensional vector. The quantum conversion module 110 may be configured to obtain the high-dimensional dataset 105 and output the quantum states 115, which encode the classically represented data of the high-dimensional dataset 105 as one or more qubits. In some embodiments, the quantum conversion module 110 may be configured to output two quantum states 115 in which each quantum state 115 represents a binary categorization of data entries included in the high-dimensional dataset 105. For example, the quantum conversion module 110 may be configured to encode data samples included in the high-dimensional dataset 105 as either a first quantum state that includes normal data or a second quantum state that includes abnormal data. In this and other examples, an initial categorization of the data samples as either normal or abnormal data may be specified by a data provider (e.g., a human user). Additionally or alternatively, the initial categorization of the data samples may be represented by a particular variable included in the high-dimensional dataset 105 for which each of the data samples includes a value. In these and other embodiments, the quantum conversion module 110 may therefore be configured to encode the data samples as either the first quantum state or the second quantum state based on any other variables.

Additionally or alternatively, the quantum conversion module 110 may be configured to encode the data samples included in the high-dimensional dataset 105 as more than two quantum states. For example, the quantum conversion module 110 may be configured to encode a particular data entry as one of five possible quantum states in which each of the quantum states represents differing degrees of abnormality of the data samples. In these and other embodiments, the quantum conversion module 110 may be configured to encode the data samples into any number of quantum states based on a particular variable that describes the data samples in the high-dimensional dataset 105.

In some embodiments, encoding of the quantum states 115 may be performed outside of the environment 100. In other words, the operations of the quantum conversion module 110 may be performed outside of the environment 100 such that the quantum states 115 are presented by the data provider. Performing the operations of the quantum conversion module 110 outside of the environment 100 may facilitate data anonymity and improve data privacy because the quantum states 115 may or may not provide information about specific data entries included in the high-dimensional dataset 105. Consequently, the environment 100 be used to identify changepoints in the high-dimensional dataset 105 without some information about individual data entries included in the high-dimensional dataset 105.

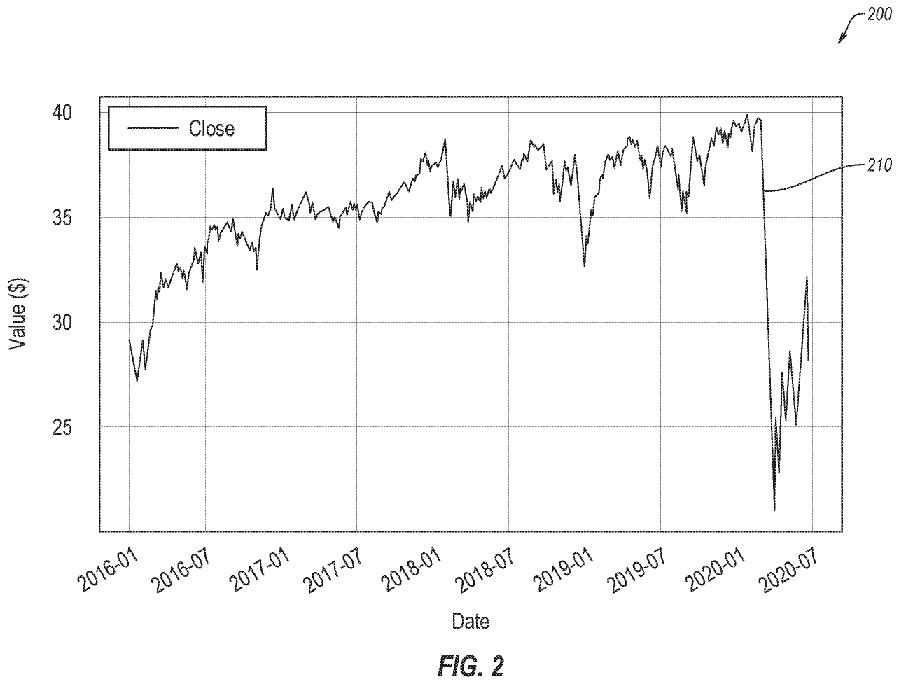

FIG. 2 illustrates an example dataset 200 that includes a changepoint 210. The dataset 200 may illustrate a monetary value, such as of a particular stock, multiple different stocks (e.g., as an index fund), a good, or a service, over a period of time. The changepoint 210 in the dataset 200 may represent a statistically abrupt shift in the data samples across one or more variables. As illustrated in FIG. 2, the changepoint 210 represents an abrupt decrease in the monetary value of a particular stock between two time points or over several time points. Although illustrated in terms of monetary value, it may be contemplated that the changepoint 210 may be detected in other variable relationships for the same dataset 200 either as a positive changepoint or as a negative changepoint depending on the related variables. For example, analysis of the dataset 200 with respect to a variable relating to the number of shares of the stock being sold may indicate that the stock experiences a positive changepoint corresponding to the approximate times of the changepoint 210.

Classical changepoint detection approaches may involve observing statistical metrics associated with the dataset 200 and identifying changes greater than a threshold amount in the observed statistical metrics at a particular point in time. As illustrated with the dataset 200, for example, a significant decrease in the monetary value associated with two or more datapoints within a short time period may represent the changepoint 210. The changepoint 210 observed with respect to the dataset 200 in terms of the monetary value of the datapoints may or may not be detectable responsive to representing the dataset 200 with respect to a different variable. Consequently, detection of changepoints in multivariate data, such as the high-dimensional dataset 105 described in relation to the environment 100, may or may not be as visually noticeable as illustrated in the dataset 200 of FIG. 2.

Returning to the description of FIG. 1, the quantum states 115 may be obtained by the quantum circuit generator 120 to generate the quantum circuit 125. In some embodiments, the quantum circuit 125 may include two or more qubits that variously include the quantum states 115. For example, the quantum states 115 may involve a first quantum state to which normal data of the high-dimensional dataset 105 was encoded and a second quantum state to which abnormal data of the high-dimensional dataset 105 was encoded. The corresponding quantum circuit 125 may be made of a first qubit including the first quantum state and a second qubit including the second quantum state. In these and other embodiments, the quantum circuit 125 may include an ancillary qubit that is initialized to a zero quantum state. As an additional or alternative example, the quantum circuit 125 may include the ancillary qubit having the initialized zero quantum state, a first qubit corresponding to a first quantum state, a second qubit corresponding to a second quantum state, and any other number of qubits corresponding to additional quantum states specified in the quantum states 115.

In some embodiments, the quantum states 115 may be obtained as a data stream rather than as an entire representation of the high-dimensional dataset 105. In other words, portions of the high-dimensional dataset 105 rather than the entirety of the high-dimensional dataset 105 may be obtained in the environment 100 (e.g., by the quantum conversion module 110 and/or the quantum circuit generator 120), and operations of the quantum conversion module 110, the quantum circuit generator 120, and/or the quantum computing module 130 may be performed with respect to the obtained portions of the high-dimensional dataset 105 rather than the entirety of the high-dimensional dataset 105. Performing operations of the environment 100 via a data streaming approach may result in piecewise processing and analysis of the high-dimensional dataset 105 such that the changepoint determination 135 is output with consideration for the obtained portions of the high-dimensional dataset 105 and/or one or more portions of the high-dimensional dataset 105 that were previously obtained in the environment 100.

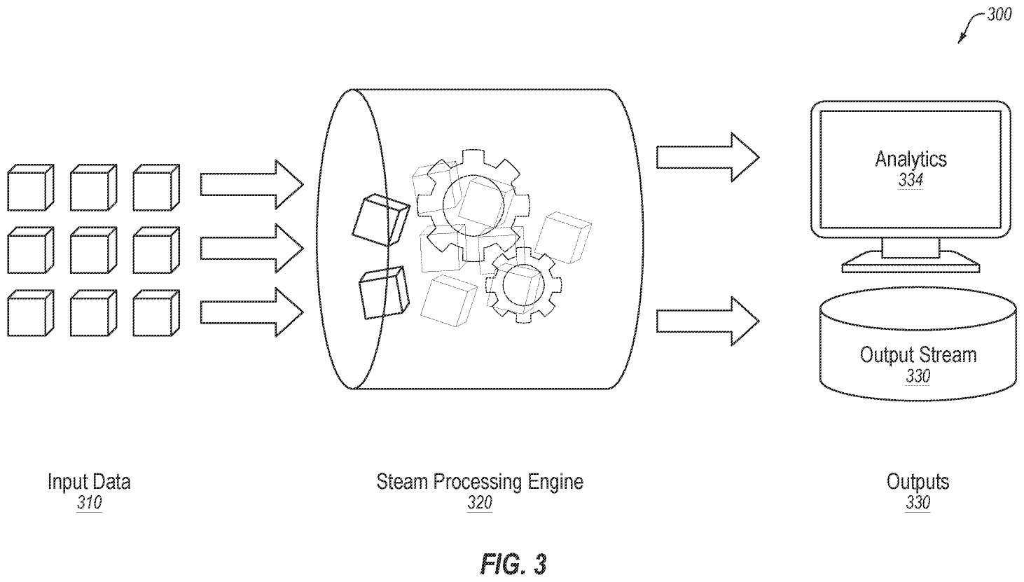

FIG. 3 illustrates an example data streaming process 300 according to one or more embodiments of the present disclosure. The data streaming process 300 may involve obtaining input data 310 in the form of several portions or packets. In some embodiments, the input data 310 may represent the high-dimensional dataset 105 and/or the quantum states 115 broken into several packets. For example, the high-dimensional dataset 105 may include packets relating to multiple different stock tickers and the performances of the stock tickers over time. The packets may break down the data relating to the performances of the stock tickers into data over a first time period, a second time period, a third time period, or any other number of time periods. Additionally or alternatively, the input data 310 may include new packets relating to the performances of the stock tickers over the past minute, five minutes, hour, two hours, three hours, day, two days, or any other time periods that may be obtained as the data becomes available.

A stream processing engine 320 may obtain the input data 310 and return outputs 330, which may include an output stream 332 and analytics 334 relating to the obtained input data 310. In some embodiments, the stream processing engine 320 may be configured to perform operations that are the same as or similar to the operations performed by the computing modules of the environment 100 of FIG. 1, including the quantum conversion module 110, the quantum circuit generator 120, and the quantum computing module 130. In these and other embodiments, the stream processing engine 320 may be configured to obtain one, two, three, or any other number of packets of the input data 310 for analysis. The stream processing engine 320 may be configured to generate the outputs 330 based on only the currently obtained packets of the input data 310. Additionally or alternatively, the stream processing engine 320 may be configured to generate the outputs 30 based on the currently obtained packets of the input data 310 and one or more of the previously obtained packets of the input data 310.

The outputs 330 may include an output stream 332 that details the input data 310 analyzed to generate the analytics 334. Additionally or alternatively, the stream processing engine 320 may be configured to apply one or more operations to the input data 310 such that the output stream 332 is changed in some capacity with respect to the corresponding input data 310. In the context of the environment 100, for example, the outputs 330 may include an output stream 332 that specifies which portions of the high-dimensional dataset 105 were obtained for analysis by the stream processing engine 320, and the analytics 334 may specify whether a changepoint was determined and if so, between which data entries the changepoint occurred.

Returning to the description of FIG. 1, the data streaming process 300 may be applied to operations in the environment 100. In some embodiments, a first portion of the high-dimensional dataset 105 may be obtained rather than the entirety of the high-dimensional dataset 105, and the quantum conversion module 110 may generate the quantum states 115 based on the obtained portions of the high-dimensional dataset 105. The quantum circuit 125 may therefore be made of the ancillary qubit and the quantum states 115 that represent the obtained portions of the high-dimensional dataset 105. As additional data, such as other portions of the high-dimensional dataset 105, are obtained by the quantum conversion module 110, additional quantum states 115 may be generated that are added to the existing quantum circuit 125 or used to generate new quantum circuits 125, which may be analyzed by the quantum computing module 130.

The quantum computing module 130 may be configured to obtain the quantum circuit 125, perform operations on the quantum circuit 125 relating to detection of changepoints in the data represented by the quantum circuit 125, and output one or more changepoint determinations 135. The quantum computing module 130 may be configured to perform a controlled-swap test on the quantum circuit 125 to make the changepoint determination 135. In some embodiments, the controlled-swap test may involve applying a first Hadamard transformation to the ancillary qubit having the zero quantum state to cause the ancillary qubit to output a quantum state having a value of zero or one. Application of the first Hadamard transformation to the ancillary qubit may return the output values of zero or one with predetermined probabilities. Responsive to the first Hadamard transformation returning an output value of zero, the first qubit and the second qubit (and/or any other qubits included in the quantum circuit 125) may remain unchanged. Responsive to the first

Hadamard transformation returning an output value of one, the first qubit and the second qubit may be swapped such that the first qubit has the second quantum state originally assigned to the second qubit, and the second qubit has the first quantum state originally assigned to the first qubit. In some embodiments, the quantum circuit 125 may include a third qubit, a fourth qubit, or any other number of qubits, and the first Hadamard transformation returning the output value of one may result in two or more of the qubits being swapped.

The controlled-swap test may involve applying a second Hadamard transformation to the ancillary qubit and observing whether a measured outcome includes a value of zero or one. The measured outcome of the second Hadamard transformation may indicate whether the first qubit and the second qubit include identical quantum states. Responsive to observing a measured outcome of one, it may be concluded that the first qubit and the second qubit do not include identical quantum states, and that a changepoint has occurred between the data samples associated with the first qubit and the data samples associated with the second qubit. Responsive to observing a measured outcome of zero, it may be concluded that the first qubit and the second qubit may include identical quantum states with a first predetermined probability.

With a second predetermined probability, however, it is also possible that the first qubit and the second qubit do not include identical quantum states responsive to observing the measured outcome of the second Hadamard transformation being zero. In other words, the second Hadamard transformation returning the output value of zero may be inconclusive for determining whether a changepoint has occurred between the data samples associated with the first qubit and the data samples associated with the second qubit. To ascertain whether a changepoint has occurred, input information in the form of new portions of the high-dimensional dataset 105 and/or new quantum states 115 may be obtained, and the operations of the quantum computing module 130 may be applied to the newly obtained input information. As operations of the quantum computing module 130 are repeated iteratively using the newly obtained input information, the probability of an output value of zero for the second Hadamard transformation indicating that no changepoint has occurred increases because observing the measured outcome having a value of one indicates with certainty that a changepoint has occurred. Therefore, processing of new input information via a data streaming process may facilitate more accurate determinations of whether a changepoint has occurred between two or more sets of data samples.

Modifications, additions, or omissions may be made to the environment 100 without departing from the scope of the present disclosure. For example, the designations of different elements in the manner described is meant to help explain concepts described herein and is not limiting. For instance, in some embodiments, the high-dimensional dataset 105, the quantum states 115, the quantum circuit 125, and/or the changepoint determination 135 are delineated in the specific manner described to help with explaining concepts described herein but such delineation is not meant to be limiting. Further, the environment 100 may include any number of other elements or may be implemented within other systems or contexts than those described.

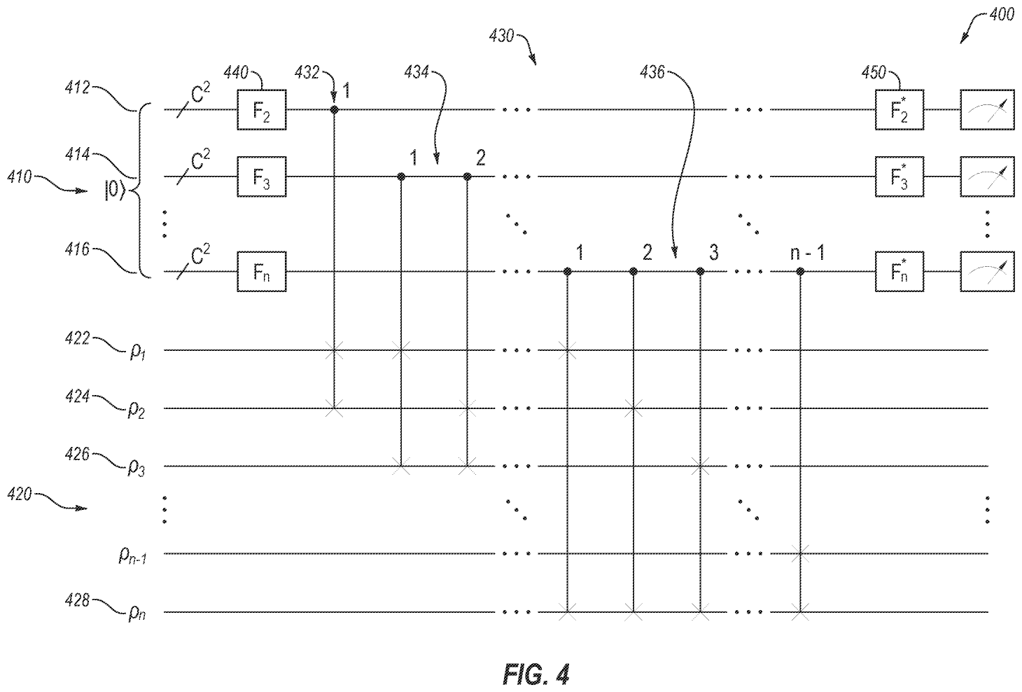

FIG. 4 illustrates an example environment 400 in which controlled swap tests involving n consecutive data streams may be performed according to one or more embodiments of the present disclosure. Each of the data streams may include a quantum circuit 430 made of an ancillary qubit 410 and two or more qubits 420. A controlled swap test may be performed for each of the quantum circuits 430 by applying a first Hadamard transformation 440 and a second Hadamard transformation 450 to the ancillary qubit 410.

Application of the controlled-swap test to the quantum circuits 430 may involve performing random permutations of swaps between the qubits 420 based on the results of applying the first Hadamard transformation 440 to the ancillary qubit 410. As the number of qubits 420 included in the quantum circuit 430 increases, the number of swap permutations correspondingly increases at a factorial rate. Applying random permutation to a particular quantum circuit 430 may be costly with respect to usage of computing resources as the number of qubits 420 increases because of the factorial growth rate relating to the number of possible swap permutations.

The environment 400 may represent quantum circuits 430 with different numbers of qubits 420. For example, a first quantum circuit 432 represents a quantum circuit that includes the ancillary qubit 412, the first qubit 422, and the second qubit 424, while a second quantum circuit 434 and a third quantum circuit 436 represent quantum circuits that include greater numbers of qubits. Although the first Hadamard transformation 440 and the second Hadamard transformation 450 are illustrated in the environment 400 as being performed before and after the qubit swaps, respectively, a series of quantum circuits that are the same as or similar to the first quantum circuit 432 may be implemented in some embodiments. In other words, the first quantum circuit 432 may be implemented repetitively or iteratively at each time step in a data streaming process to identify changepoints in some embodiments.

In some embodiments, a series of two-qubit swaps may be performed to generate a particular permutation arrangement of the quantum circuits 430. For example, the first quantum circuit 432 may only include an ancillary qubit 412, a first qubit 422, and a second qubit 424. Applying a controlled-swap test to the first quantum circuit 432 may involve swapping the quantum state associated with the first qubit 422 and a quantum state associated with the second qubit 424. In comparison, the second quantum circuit 434 may include an ancillary qubit 414, the first qubit 422, the second qubit 424, and a third qubit 426. To arrange the second quantum circuit 434, the second Hadamard transformation 450 may involve performing a first swap operation such that the quantum state associated with the first qubit 422 and a quantum state associated with the third qubit 426 are interchanged. The second Hadamard transformation 450 may involve performing a second swap operation that interchanges the quantum state associated with the second qubit 424 and the quantum state associated with the third qubit 426, which was originally the quantum state associated with the first qubit 422, resulting in the second quantum circuit 434 having an arrangement in which the first qubit 422 has a quantum state originally associated with the third qubit 426, the second qubit 424 has a quantum state originally associated with the first qubit 422, and the third qubit 426 has a quantum state originally associated with the second qubit 424.

In some embodiments, application of the controlled-swap test via a series of swap operations between two qubits included in a particular quantum circuit may be used in lieu of a random permuted arrangement of the qubits. For example, the third quantum circuit 436 may include n qubits including the first qubit 422, the second qubit 424, the third qubit 426, and up to an n-th qubit 428. Performing the series of swap operations rather than computationally generating a particular permutation of qubits for a particular quantum circuit may accelerate performance of operations in the environment 400 because performing the series of swap operations may scale linearly with respect to the number of qubits included in a particular quantum circuit rather than at an exponential-factorial rate.

Modifications, additions, or omissions may be made to the environment 400 without departing from the scope of the present disclosure. For example, the designations of different elements in the manner described is meant to help explain concepts described herein and is not limiting. For instance, in some embodiments, the ancillary qubits 410, the qubits 420, the quantum circuits 430, the first Hadamard transformation 440, and/or the second Hadamard transformation 450 are delineated in the specific manner described to help with explaining concepts described herein but such delineation is not meant to be limiting. Further, the controlled swap tests of the environment 400 may include any number of other elements or may be implemented within other systems or contexts than those described.

FIG. 5 is a flowchart of an example method 500 of determining whether a changepoint occurs in high-dimensional datasets according to one or more embodiments of the present disclosure. The method 500 may be performed by any suitable system, apparatus, or device. For example, the high-dimensional dataset 105, the quantum states 115, the quantum circuit 125, and/or the changepoint determination 135 of FIG. 1 may perform one or more operations associated with the method 500. Although illustrated with discrete blocks, the steps and operations associated with one or more of the blocks of the method 500 may be divided into additional blocks, combined into fewer blocks, or eliminated, depending on the particular implementation.

The method 500 may begin at block 502, where a first quantum state and a second quantum state are obtained. The first quantum state may represent a first data subset of a multivariate dataset that describes data samples in terms of several variables and the second quantum state representing a second data subset of the multivariate dataset. In some embodiments, the data samples may be included in the first data subset or the second data subset based on a predetermined categorization of the data samples as normal data or abnormal data. For example, the data samples may be categorized as normal data being included in the first group, and the data samples may be categorized as abnormal data being included in the second group. In some embodiments, the first quantum state and the second quantum state may be obtained as part of a data stream in which the first quantum state and the second quantum state are encrypted upon being obtained and are discarded after observing a measurement outcome of the second Hadamard transformation.

At block 504, a quantum circuit that includes an ancillary qubit may be configured that includes the obtained first quantum state and the obtained second quantum state. In some embodiments, a third quantum state representing a third data subset of the multivariate dataset may be obtained, and the quantum circuit may be configured to include a third qubit having the third quantum state.

At block 506, a first Hadamard transformation may be applied to the ancillary qubit in which the first Hadamard transformation returning a particular output value (e.g., an output value of one) indicates that the first qubit and the second qubit of the quantum circuit are to be swapped. In some embodiments involving a third qubit or other additional qubits in the quantum circuit, the first Hadamard transformation returning the particular output value may result in swapping two or more quantum states associated with the qubits included in the quantum circuit.

At block 508, the first qubit and the second qubit may be swapped responsive to the first Hadamard transformation returning the particular output value such that the second qubit represents the first quantum state and the first qubit represents the second quantum state. Responsive to the first Hadamard transformation not returning the particular output value (e.g., returning an output value of zero), the first qubit and the second qubit may not be swapped.

At block 510, a second Hadamard transformation may be applied to the ancillary qubit and a measurement outcome of the second Hadamard transformation may be observed.

At block 512, whether a changepoint occurs between the data samples corresponding to a first data subset associated with the first quantum state and the data samples corresponding to a second data subset associated with the second quantum state may be determined based on the observed measurement outcome. Responsive to observing the measurement outcome having a value of one, the changepoint may be determined to have occurred. Responsive to observing the measurement outcome having a value of zero, it may be concluded that the changepoint has not occurred between the data samples corresponding to the first data subset and the data samples corresponding to the second data subset. Additionally or alternatively, it may be possible that the changepoint has occurred between the data samples corresponding to the first data subset and the data samples corresponding to the second data subset responsive to observing that the measurement outcome has a value of zero.

Modifications, additions, or omissions may be made to the method 500 without departing from the scope of the disclosure. For example, the designations of different elements in the manner described is meant to help explain concepts described herein and is not limiting. Further, the method 500 may include any number of other elements or may be implemented within other systems or contexts than those described.

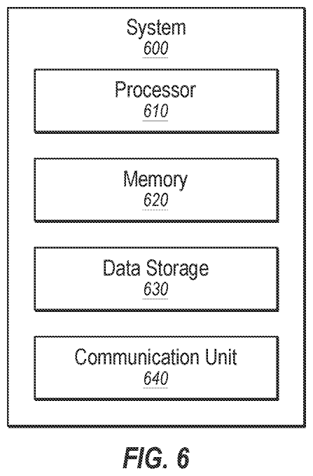

FIG. 6 is an example computer system 600 according to one or more embodiments of the present disclosure. The computing system 600 may include a processor 610, a memory 620, a data storage 630, and/or a communication unit 640, which all may be communicatively coupled. Any or all of the environment 100 of FIG. 1 may be implemented as a computing system consistent with the computing system 600.

Generally, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 1010 may include any number of processors distributed across any number of network or physical locations that are configured to perform individually or collectively any number of operations described in the present disclosure. In some embodiments, the processor 610 may interpret and/or execute program instructions and/or process data stored in the memory 620, the data storage 630, or the memory 620 and the data storage 630. In some embodiments, the processor 610 may fetch program instructions from the data storage 630 and load the program instructions into the memory 620.

After the program instructions are loaded into the memory 620, the processor 610 may execute the program instructions, such as instructions to cause the computing system 600 to perform the operations of the method 500 of FIG. 5. For example, the computing system 600 may execute the program instructions to obtain the first quantum state and the second quantum state, configure a quantum circuit, apply the first Hadamard transformation to the ancillary qubit, swap the first qubit and the second qubit, apply the second Hadamard transformation, and/or determine whether the changepoint occurs.

The memory 620 and the data storage 630 may include computer-readable storage media or one or more computer-readable storage mediums for having computer-executable instructions or data structures stored thereon. Such computer-readable storage media may be any available media that may be accessed by a general-purpose or special-purpose computer, such as the processor 610. For example, the memory 620 and/or the data storage 630 may include the high-dimensional dataset 105, the quantum states 115, the quantum circuit 125, and/or the changepoint determination 135 of FIG. 1. In some embodiments, the computing system 600 may or may not include either of the memory 620 and the data storage 630.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 610 to perform a particular operation or group of operations.

The communication unit 640 may include any component, device, system, or combination thereof that is configured to transmit or receive information over a network. In some embodiments, the communication unit 640 may communicate with other devices at other locations, the same location, or even other components within the same system. For example, the communication unit 640 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 640 may permit data to be exchanged with a network and/or any other devices or systems described in the present disclosure. For example, the communication unit 640 may allow the system 600 to communicate with other systems, such as computing devices and/or other networks.

One skilled in the art, after reviewing this disclosure, may recognize that modifications, additions, or omissions may be made to the system 600 without departing from the scope of the present disclosure. For example, the system 600 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
obtaining a first quantum state representing a first data subset of a multivariate dataset that describes a plurality of data samples in terms of a plurality of variables;
obtaining a second quantum state representing a second data subset of the multivariate dataset;
configuring a quantum circuit that includes:
an ancillary qubit initialized to a zero state,
a first qubit including the first quantum state, and
a second qubit including the second quantum state;
applying a first Hadamard transformation to the ancillary qubit in which the first Hadamard transformation returning a particular value results in swapping the first qubit and the second qubit;
responsive to the first Hadamard transformation returning the particular value, swapping the first qubit and the second qubit such that the second qubit represents the first quantum state and the first qubit represents the second quantum state;
applying a second Hadamard transformation to the ancillary qubit and observing a measurement outcome of the second Hadamard transformation; and
responsive to the measurement outcome being observed as having a value of zero, determining that a changepoint does not occur between the data samples corresponding to the first data subset and the data samples corresponding to the second data subset.

2. The method of claim 1, further comprising:
applying the second Hadamard transformation to the ancillary qubit and observing a second measurement outcome; and
responsive to the second measurement outcome being observed as having a value of one, determining that a changepoint occurs between the data samples corresponding to the first data subset and the data samples corresponding to the second data subset.

3. The method of claim 1, further comprising:
applying the second Hadamard transformation to the ancillary qubit and observing a third measurement outcome; and
responsive to the third measurement outcome being observed as having a value of zero, determining that a changepoint occurs between the data samples corresponding to the first data subset and the data samples corresponding to the second data subset.

4. The method of claim 1, further comprising:
obtaining a third quantum state that represents a third data subset of the multivariate dataset;
configuring the quantum circuit to include a third qubit that includes the third quantum state;
applying the first Hadamard transformation to the ancillary qubit in which the first Hadamard transformation not returning the particular value results in the first qubit, the second qubit, and the third qubit not being swapped.

5. The method of claim 1, further comprising:
obtaining a third quantum state that represents a third data subset of the multivariate dataset;
configuring the quantum circuit to include a third qubit that includes the third quantum state;
applying the first Hadamard transformation to the ancillary qubit in which the first Hadamard transformation returning the particular value results in swapping one or more quantum states associated with the first qubit, the second qubit, and the third qubit;
responsive to the first Hadamard transformation returning the particular value, swapping the one or more quantum states associated with the first qubit, the second qubit, and the third qubit;
applying the second Hadamard transformation to the ancillary qubit and observing the measurement outcome of the second Hadamard transformation; and
responsive to observing the measurement outcome having the value of one, determining that a changepoint occurs between the data samples corresponding to the swapped one or more quantum states associated with the first qubit, the second qubit, and the third qubit.

6. The method of claim 1, wherein the first quantum state and the second quantum state are obtained as part of a data stream in which the first quantum state and the second quantum state are encrypted upon being obtained and are discarded after observing the measurement outcome.

7. The method of claim 1, wherein the first data subset includes data samples categorized as normal data and the second data subset includes data samples categorized as abnormal data.

8. One or more non-transitory computer-readable storage media configured to store instructions that, in response to being executed, cause a system to perform operations, the operations comprising:
obtaining a first quantum state representing a first data subset of a multivariate dataset that describes a plurality of data samples in terms of a plurality of variables;
obtaining a second quantum state representing a second data subset of the multivariate dataset;
configuring a quantum circuit that includes:
an ancillary qubit initialized to a zero state,
a first qubit including the first quantum state, and
a second qubit including the second quantum state;
applying a first Hadamard transformation to the ancillary qubit in which the first Hadamard transformation returning a particular value results in swapping the first qubit and the second qubit;
responsive to the first Hadamard transformation returning the particular value, swapping the first qubit and the second qubit such that the second qubit represents the first quantum state and the first qubit represents the second quantum state;
applying a second Hadamard transformation to the ancillary qubit and observing a measurement outcome of the second Hadamard transformation; and
responsive to the measurement outcome being observed as having a value of zero, determining that a changepoint does not occur between the data samples corresponding to the first data subset and the data samples corresponding to the second data subset.

9. The one or more non-transitory computer-readable storage media of claim 8, wherein the operations further comprise:
applying the second Hadamard transformation to the ancillary qubit and observing a second measurement outcome; and
responsive to the second measurement outcome being observed as having a value of one, determining that a changepoint occurs between the data samples corresponding to the first data subset and the data samples corresponding to the second data subset.

10. The one or more non-transitory computer-readable storage media of claim 8, wherein the operations further comprise:
applying the second Hadamard transformation to the ancillary qubit and observing a third measurement outcome; and
responsive to the third measurement outcome being observed as having a value of zero, determining that a changepoint occurs between the data samples corresponding to the first data subset and the data samples corresponding to the second data subset.

11. The one or more non-transitory computer-readable storage media of claim 8, wherein the operations further comprise:
obtaining a third quantum state that represents a third data subset of the multivariate dataset;
configuring the quantum circuit to include a third qubit that includes the third quantum state;
applying the first Hadamard transformation to the ancillary qubit in which the first Hadamard transformation not returning the particular value results in the first qubit, the second qubit, and the third qubit not being swapped.

12. The one or more non-transitory computer-readable storage media of claim 8, wherein the operations further comprise:
obtaining a third quantum state that represents a third data subset of the multivariate dataset;
configuring the quantum circuit to include a third qubit that includes the third quantum state;
applying the first Hadamard transformation to the ancillary qubit in which the first Hadamard transformation returning the particular value results in swapping one or more quantum states associated with the first qubit, the second qubit, and the third qubit;
responsive to the first Hadamard transformation returning the particular value, swapping the one or more quantum states associated with the first qubit, the second qubit, and the third qubit;
applying the second Hadamard transformation to the ancillary qubit and observing the measurement outcome of the second Hadamard transformation; and
responsive to observing the measurement outcome having the value of one, determining that a changepoint occurs between the data samples corresponding to the swapped one or more quantum states associated with the first qubit, the second qubit, and the third qubit.

13. The one or more non-transitory computer-readable storage media of claim 8, wherein the first quantum state and the second quantum state are obtained as part of a data stream in which the first quantum state and the second quantum state are encrypted upon being obtained and are discarded after observing the measurement outcome.

14. The one or more non-transitory computer-readable storage media of claim 8, wherein the data samples are included in the first data subset or the second data subset based on a predetermined categorization of the data samples as normal data or abnormal data, the data samples categorized as normal data being included in the first data subset and the data samples categorized as abnormal data being included in the second data subset.

15. A system, comprising:
one or more processors; and
one or more non-transitory computer-readable storage media configured to store instructions that, in response to being executed, cause the system to perform operations, the operations comprising:
obtaining a first quantum state representing a first data subset of a multivariate dataset that describes a plurality of data samples in terms of a plurality of variables;
obtaining a second quantum state representing a second data subset of the multivariate dataset;
configuring a quantum circuit that includes:
an ancillary qubit initialized to a zero state,
a first qubit including the first quantum state, and
a second qubit including the second quantum state;
applying a first Hadamard transformation to the ancillary qubit in which the first Hadamard transformation returning a particular value results in swapping the first qubit and the second qubit;
responsive to the first Hadamard transformation returning the particular value, swapping the first qubit and the second qubit such that the second qubit represents the first quantum state and the first qubit represents the second quantum state;
applying a second Hadamard transformation to the ancillary qubit and observing a measurement outcome of the second Hadamard transformation; and
responsive to the measurement outcome being observed as having a value of zero, determining that a changepoint does not occur between the data samples corresponding to the first data subset and the data samples corresponding to the second data subset.

16. The system of claim 15, wherein the operations further comprise:
applying the second Hadamard transformation to the ancillary qubit and observing a second measurement outcome; and
responsive to the second measurement outcome being observed as having a value of one, determining that a changepoint occurs between the data samples corresponding to the first data subset and the data samples corresponding to the second data subset.

17. The system of claim 15, wherein the operations further comprise:
applying the second Hadamard transformation to the ancillary qubit and observing a third measurement outcome; and
responsive to the third measurement outcome being observed as having a value of zero, determining that a changepoint occurs between the data samples corresponding to the first data subset and the data samples corresponding to the second data subset.

18. The system of claim 15, wherein the operations further comprise:
obtaining a third quantum state that represents a third data subset of the multivariate dataset;
configuring the quantum circuit to include a third qubit that includes the third quantum state;
applying the first Hadamard transformation to the ancillary qubit in which the first Hadamard transformation not returning the particular value results in the first qubit, the second qubit, and the third qubit not being swapped.

19. The system of claim 15, wherein the operations further comprise:
obtaining a third quantum state that represents a third data subset of the multivariate dataset;
configuring the quantum circuit to include a third qubit that includes the third quantum state;
applying the first Hadamard transformation to the ancillary qubit in which the first Hadamard transformation returning the particular value results in swapping one or more quantum states associated with the first qubit, the second qubit, and the third qubit;
responsive to the first Hadamard transformation returning the particular value, swapping the one or more quantum states associated with the first qubit, the second qubit, and the third qubit;
applying the second Hadamard transformation to the ancillary qubit and observing the measurement outcome of the second Hadamard transformation; and
responsive to observing the measurement outcome having the value of one, determining that a changepoint occurs between the data samples corresponding to the swapped one or more quantum states associated with the first qubit, the second qubit, and the third qubit.

20. The system of claim 15, wherein the first quantum state and the second quantum state are obtained as part of a data stream in which the first quantum state and the second quantum state are encrypted upon being obtained and are discarded after observing the measurement outcome.
